(19) United States
(12) Patent Application Publication
(10) Pub. No.: US 2009/0172277 A1
(43) Pub. Date: Jul. 2, 2009

(54) RAID LEVEL MIGRATION METHOD FOR PERFORMING ONLINE RAID LEVEL MIGRATION AND ADDING DISK TO DESTINATION RAID, AND ASSOCIATED SYSTEM

(76) Inventor: Yi-Chun Chen, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/188,176

(22) Filed: Aug. 7, 2008

(30) Foreign Application Priority Data
Dec. 31, 2007 (TW) 096151395

(51) Int. Cl. G06F 12/00; G06F 12/02

(52) U.S. Cl. 711/114; 711/E12.001; 711/E12.002

(57) ABSTRACT

A Redundant Array of Independent Disks (RAID) level migration method for performing an online RAID level migration and adding a disk to a destination RAID is provided. First, the required information for migration is specified, and then a degraded mode is used to establish the destination RAID, and file system is built on the destination RAID. The file system of the source disk device is configured to be read-only, and all data of the source disk device are duplicated to the destination RAID. After completing file duplication, the destination RAID replaces the source disk device. The operation of the source disk device is stopped and the source disk device is added to the destination RAID. As a result, the RAID migration is accomplished. In addition, an associated RAID level migration system is further provided.

### BACKGROUND OF THE INVENTION

1. Field of the Invention

The present invention relates to a Redundant Array of Independent Disks (RAID) level migration method and system, and more particularly, to a RAID level migration method and system capable of migrating a level of a previously established RAID to another level and adding a disk to the previously established RAID when a volume or a level of the previously established RAID does not conform to demands.

2. Description of the Prior Art

RAID is a logic drive comprising a plurality of physical drives or disk partitions and further comprising a RAID controller. The same data are respectively stored in different data blocks in a plurality of physical drives to improve data loading performance when data are loaded at the same time and also improve data fault tolerance. For RAIDs, there are several kinds of levels (which are also known as configurations), comprising RAID Level 0 (i.e. RAID-0), RAID Level 1 (i.e. RAID-1), RAID Level 5 (i.e. RAID-5), RAID Level 6 (i.e. RAID-6), and so on.

If a volume or a level of a previously established RAID does not conform to demands, a user must remove the previously established RAID and establish a new RAID. In order to complete such an operation, it is required to backup data previously stored in the previously established RAID and store the backup data back to the new RAID after it is established. It not only costs additional storage spaces and time but also needs to stop all data access services in the meanwhile.

### SUMMARY OF THE INVENTION

It is therefore an objective of the present invention to provide a RAID level migration method for performing an online RAID level migration and adding a new disk without stopping data access service nor costing additional storage spaces, and to provide an associated system, in order to solve the above-mentioned problem.

The RAID level migration method and system of the present invention can be utilized for migrating a level of a previously established RAID to another level online and retaining original data when a volume or a level of the previously established RAID does not comfort to demands, in order to extend storage volumes and to upgrade the level of the RAID so that data fault tolerance is therefore enhanced.

According to an embodiment of the present invention, the RAID level migration method comprises steps of: specifying a source disk device, a disk, and a destination RAID level; determining whether the volume of the destination RAID is less than that of the source disk device, if yes, terminating an online RAID level migration since the volume of the destination RAID is not sufficient for the uses of the source disk device to store the data after migration; if the source disk device is a RAID, removing at least one disk of the source disk device and making the source disk device operate in a degraded mode; establishing the destination RAID in a degraded mode and building a first file system on the destination RAID; configuring a second file system of the source disk device to be read-only and duplicating data in the source disk device to the destination RAID; replacing the source disk device with the destination RAID to provide data access service; and stopping operation of the source disk device and adding the source disk device to the destination RAID in order to accomplish the online RAID level migration.

According to an embodiment of the present invention, the RAID level migration system comprises: a migration information specifying unit; a migration operation assignment unit; a disk device management unit; and a file system management unit. The migration information specifying unit is arranged to specify migration information of a source disk device, a disk, and a destination RAID level. The migration operation assignment unit is arranged to receive the migration information and is arranged to generate system status information according to the migration information. The disk device management unit is coupled to the migration operation assignment unit, and is utilized for receiving the system status information, refreshing and transmitting the system status information to the migration operation assignment unit, confirming a status of the source disk device, removing at least one disk of the source disk device to make the source disk device operate in a degraded mode, establishing the destination RAID in a degraded mode, and adding the source disk device to the destination RAID. The file system management unit is coupled to the migration operation assignment unit, and is utilized for receiving the system status information, refreshing and transmitting the system status information to the migration operation assignment unit, building a first file system on the destination RAID, configuring a second file system of the source disk device to be read-only, and duplicating data of the source device disk to the destination RAID.

Besides, the RAID level migration system further comprises a system information management unit and an exception processing unit. The system information management unit is utilized for receiving the system status information and storing the system status information in a system information log file. The exception processing unit is utilized for loading the system status information in the system information log file, and terminating an online RAID level migration when the system status information indicates that the volume of the destination RAID is less than that of the source disk device.

The advantages and spirits of the present invention can be realized in detail by referring to the following embodiments and figures.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart of a Redundant Array of Independent Disks (RAID) level migration method according to an embodiment of the present invention.

FIG. 2 is a diagram of a RAID level migration system according to an embodiment of the present invention.

### DETAILED DESCRIPTION

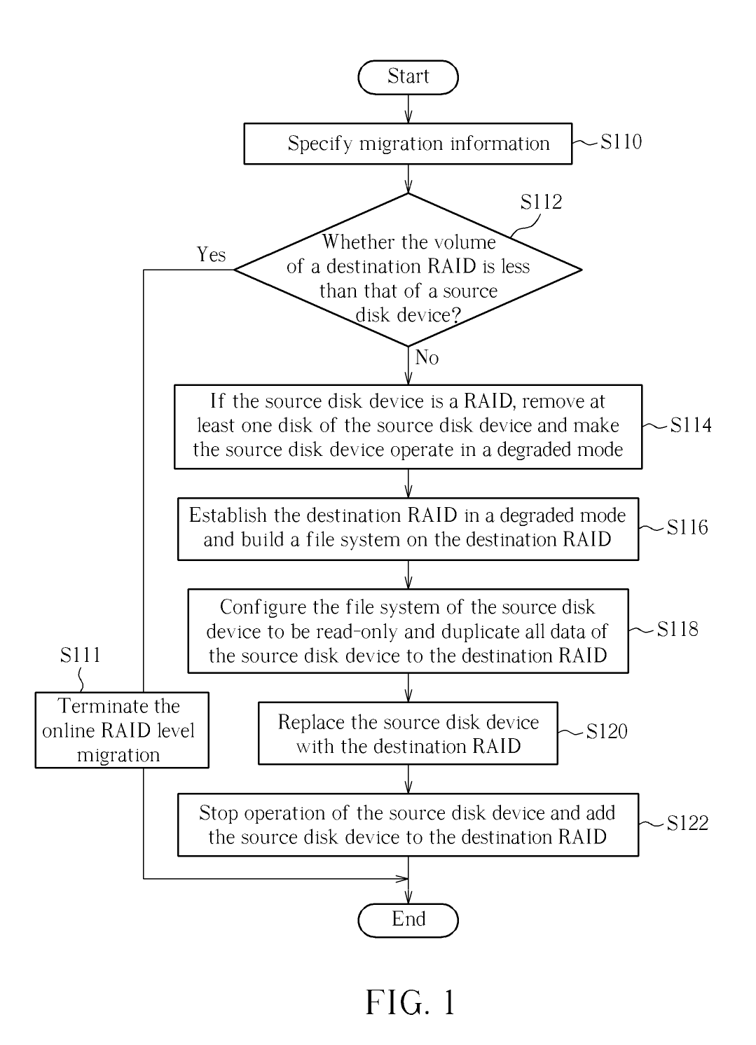

Please refer to FIG. 1. FIG. 1 illustrates a flowchart of a Redundant Array of Independent Disks (RAID) level migration method for performing an online RAID level migration and adding a disk to a destination RAID in accordance with an embodiment of the present invention.

At first, in Step S110, specify migration information of a source disk device, the disk, and a destination RAID level (i.e. a level of the destination RAID), where the migration information is required for performing the online RAID level migration.

Then, in Step S112, confirm the status of the specified source disk and determine whether the volume of the destination RAID is less than that of the source disk device according to the volume of the disk and the destination RAID level. In Step S112, if the volume of the destination RAID is less than that of the source disk device and is not sufficient for storing data after migration, Step S111 is entered; otherwise, Step S114 is entered.

In Step S111, as it is determined that the volume of the destination RAID is less than that of the source disk device according to the volume of the disk and the destination RAID level, which means the volume of the destination RAID is not sufficient for storing data of the source disk device, terminate the online RAID level migration.

In Step S114, if the source disk device is a RAID, remove at least one disk or disk partition of the source disk device to make the source disk device operate in a degraded mode with minimum requirements regarding disks or disk partitions.

Then, in Step S116, establish the destination RAID in a degraded mode with minimum requirements regarding disks or disk partitions, and build a first file system on the destination RAID. Accordingly, in Step S118, configure a second file system of the source disk device to be read-only, duplicate all data in the source disk device to the destination RAID. Then, in Step S120, replace the source disk device with the destination RAID to continue to provide data access service. Finally, in Step S122, stop operation of the source disk device, and add the source disk device to the destination RAID in order to accomplish the online RAID level migration.

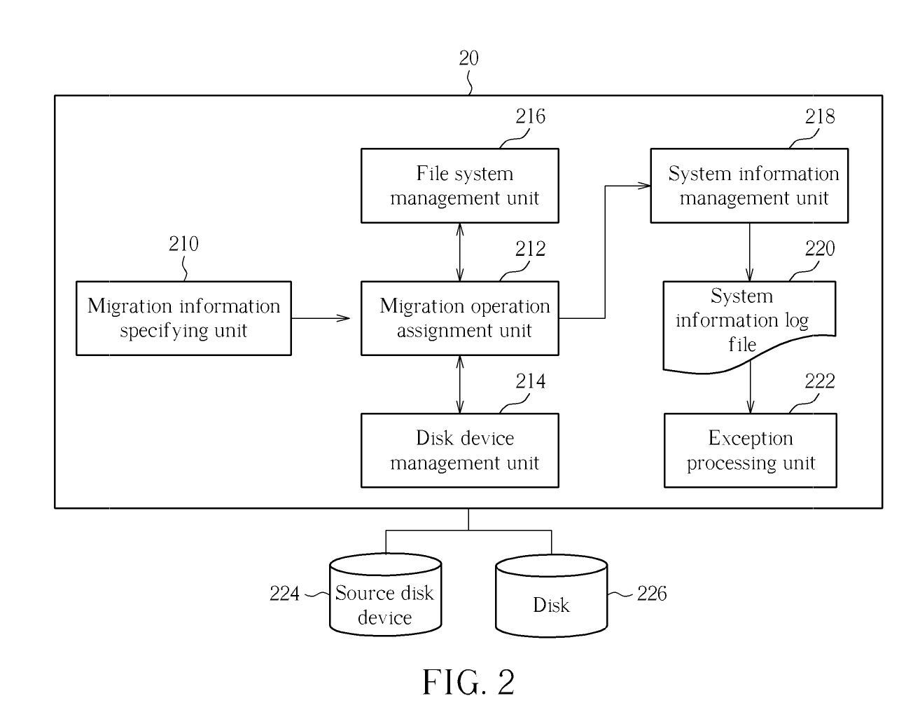

FIG. 2 illustrates a diagram of a RAID level migration system 20 for performing an online RAID level migration and adding a disk to a destination RAID according to an embodiment of the present invention. First of all, a user specifies migration information of a source disk device 224, a disk 226, and a destination RAID level.

After a migration operation assignment unit 212 receives the migration information transmitted by a migration information specifying unit 210, the migration operation assignment unit 212 generates a system status information according to contents of the migration information in order to indicate contents of the migration information and contents of the current system status information of the RAID level migration system 20, and further transmit the system status information to a disk device management unit 214. Then, after receiving the system status information, the disk device management unit 214 confirms the status of the specified source disk device 224 according to the contents of the system status information, and determines whether the volume of the destination RAID is less than that of the source disk device 224 according to the volume of the disk 226 and the destination RAID level. If the volume of the disk 226 is not sufficient for level migration, that is, the volume of the destination RAID is not sufficient for the source disk device 224 to store data, the disk device management unit 214 refreshes the contents of the system status information and transmit it to the migration operation assignment unit 212 in order to indicate that the volume of the destination RAID is less than that of the source disk device 224.

The system information management unit 218 receives the system status information transmitted by the migration operation assignment unit 212 and stores the system status information in a system information log file 220. An exception processing unit 222 loads the system status information in the system information log file 220, and terminates the online RAID level migration of the RAID level migration system 20 when the contents of the system status information indicates that the volume of the destination RAID is less than that of the source disk device 224.

If the volume of the destination RAID is sufficient for the uses of the source disk device 224, the disk device management unit 214 then confirms whether the source disk device 224 is a RAID. If the source disk device 224 is a RAID, the disk device management unit 214 removes at least one disk or disk partition of the source disk device 224 to make the source disk device 224 operate in a degraded mode with minimum requirements regarding disks or disk partitions. Then, the disk device management unit 214 subsequently establishes the destination RAID in a degraded mode with minimum requirements regarding disks or disk partitions. At last, the disk device management unit 214 refreshes the contents of the system status information and transmits it to the migration operation assignment unit 212 to indicate that the status of the source disk device 224 has been confirmed and that the destination RAID has already been established.

After a file system management unit 216 receives the system status information indicating that the destination RAID has already been established, the file system management unit 216 builds a first file system on the destination RAID and configures a second file system of the source disk device 224 to be read-only and further duplicates all data of the source disk device 224 to the destination RAID. After data duplication, the migration operation assignment unit 212 asks the disk device management unit 214 to replace the source disk device 224 with the destination RAID in order to continue to provide data access service. Finally, the disk device management unit 214 stops operation of the source disk device 224, adds the source disk device 224 to the destination RAID, and refreshes the contents of the system status information and transmits it to the migration operation assignment unit 212 to indicate that the online RAID level migration has been accomplished.

Regarding the RAID level migration method and system implemented according to different embodiments of the present invention, the source disk device can be a RAID, a physical drive, or a disk partition, and the disk can be a physical drive or a disk partition. In addition, when the source disk device is a RAID, the RAID level migration method and system implemented according to different embodiments of the present invention are capable of migrating a level of the source disk device to another level. For example, when a level of the RAID is RAID-1, the destination RAID level can be RAID-5, RAID-6 or RAID-10. That is, the RAID level migration method and system migrate the source disk device of RAID-1 to a RAID of RAID-5, RAID-6, or RAID-10. In another example, when a level of the RAID is RAID-5, the destination RAID level can be RAID-6 or RAID-10. That is, the RAID level migration method and system migrate the source disk device of RAID-5 to a RAID of RAID-6 or RAID-10. In another example, when a level of the RAID is RAID-6, the destination RAID level can be RAID-10. That is, the RAID level migration method and system migrate the source disk device of RAID-6 to a RAID of RAID-10.

When the source disk device is a physical drive or a disk partition, the RAID level migration method and system implemented according to different embodiments of the present invention are capable of migrating the source disk device to a RAID of RAID-1, RAID-5, RAID-6, or RAID-10.

In contrast to the conventional RAID level migration method, the RAID level migration method and system of the present invention do not need additional storage spaces for temporarily storing data, and the RAID level migration method and system of the present invention can just perform an online RAID level migration without stopping original data access service on the disk, in order to extend storage volumes and upgrade the level of the RAID and further enhance data fault tolerance.

Those skilled in the art will readily observe that numerous modifications and alterations of the method and system may be made while retaining the teachings of the present invention.

What is claimed is:

1. A Redundant Array of Independent Disks (RAID) level migration method for performing an online RAID level migration and adding a disk to a destination RAID, comprising steps of:
(a) specifying a source disk device, the disk, and a destination RAID level;
(b) determining whether the volume of the destination RAID is less than that of the source disk device, if yes, terminating the online RAID level migration, otherwise, executing step (c);
(c) if the source disk device is a RAID, removing at least one disk of the source disk device and making the source disk device operate in a degraded mode;
(d) establishing the destination RAID in a degraded mode and building a first file system on the destination RAID;
(e) configuring a second file system of the source disk device to be read-only and duplicating data in the source disk device to the destination RAID;
(f) replacing the source disk device with the destination RAID to provide data access service; and
(g) stopping operation of the source disk device and adding the source disk device to the destination RAID.

2. The RAID level migration method of claim 1, wherein the source disk device is a RAID.

3. The RAID level migration method of claim 2, wherein a level of the RAID is RAID-1, and the destination RAID level is RAID-5, RAID-6 or RAID-10.

4. The RAID level migration method of claim 2, wherein a level of the RAID is RAID-5, and the destination RAID level is RAID-6 or RAID-10.

5. The RAID level migration method of claim 2, wherein a level of the RAID is RAID-6, and the destination RAID level is RAID-10.

6. The RAID level migration method of claim 1, wherein the source disk device is a physical drive.

7. The RAID level migration method of claim 6, wherein the destination RAID level is RAID-1, RAID-5, RAID-6 or RAID-10.

8. The RAID level migration method of claim 1, wherein the disk is a physical drive or a disk partition.

9. A Redundant Array of Independent Disks (RAID) level migration system for performing an online RAID level migration and adding a disk to a destination RAID, comprising:
a migration information specifying unit for specifying migration information of a source disk device, the disk, and a destination RAID level;
a migration operation assignment unit for receiving the migration information, and generating system status information according to the migration information;
a disk device management unit, coupled to the migration operation assignment unit, for receiving the system status information, refreshing and transmitting the system status information to the migration operation assignment unit, confirming a status of the source disk device, removing at least one disk of the source disk device to make the source disk device operate in a degraded mode, establishing the destination RAID in a degraded mode, and adding the source disk device to the destination RAID; and
a file system management unit, coupled to the migration operation assignment unit, for receiving the system status information, refreshing and transmitting the system status information to the migration operation assignment unit, building a first file system on the destination RAID, configuring a second file system of the source disk device to be read-only, and duplicating data of the source device disk to the destination RAID.

10. The RAID level migration system of claim 9, further comprising:
a system information management unit for receiving the system status information and storing the system status information in a system information log file.

11. The RAID level migration system of claim 10, further comprising:
an exception processing unit for loading the system status information in the system information log file, and terminating the online RAID level migration when the system status information indicates that the volume of the destination RAID is less than that of the source disk device.

12. The RAID level migration system of claim 9, wherein the source disk device is a RAID.

13. The RAID level migration system of claim 12, wherein a level of the RAID is RAID-1, and the destination RAID level is RAID-5, RAID-6 or RAID-10.

14. The RAID level migration system of claim 12, wherein a level of the RAID is RAID-5, and the destination RAID level is RAID-6 or RAID-10.

15. The RAID level migration system of claim 12, wherein a level of the RAID is RAID-6, and the destination RAID level is RAID-10.

16. The RAID level migration system of claim 9, wherein the source disk device is a physical drive.

17. The RAID level migration system of claim 16, wherein the destination RAID level is RAID-1, RAID-5, RAID-6 or RAID-10.

18. The RAID level migration system of claim 9, wherein the disk is a physical drive or a disk partition.
